(19) United States
(12) Patent Application Publication
(10) Pub. No.: US 2023/0214633 A1
(43) Pub. Date: Jul. 6, 2023

(54) NEURAL RANKING MODEL FOR GENERATING SPARSE REPRESENTATIONS FOR INFORMATION RETRIEVAL

(71) Applicant: NAVER CORPORATION, Seongnam-si (KR)

(72) Inventors: Stéphane Clinchant, Meylan (FR); Thibault Formal, Grenoble (FR); Carlos Lassance, Grenoble (FR); Benjamin PIwowarski, Paris (FR)

(21) Appl. No.: 17/804,983

(22) Filed: Jun. 1, 2022

Related U.S. Application Data
(60) Provisional application No. 63/266,194, filed on Dec. 30, 2021.

(51) Int. Cl. G06N 3/04; G06N 3/08; G06F 40/284

(52) U.S. Cl. CPC G06N 3/0481; G06N 3/08; G06F 40/284

(57) ABSTRACT

A neural model for representing an input sequence over a vocabulary in a ranker of a neural information retrieval model. An input sequence is embedded based at least on the vocabulary. An importance of each token over the vocabulary is predicted with respect to each token of the embedded input sequence. A predicted term importance of the input sequence over the vocabulary is determined by performing an activation over the embedded input sequence.

### PRIORITY CLAIM

This application claims priority to and benefit from U.S. Provisional Patent Application Ser. No. 63/266,194, filed Dec. 30, 2021, which application is incorporated in its entirety by reference herein.

### FIELD

The present disclosure relates generally to machine learning, and more particularly to methods and systems for training neural language models such as ranking models for information retrieval.

### BACKGROUND

For neural information retrieval (IR), it would be useful to improve first-stage retrievers in ranking pipelines. For instance, while bag-of-words (BOW) models remain strong baselines for first-stage retrieval, they suffer from the longstanding vocabulary mismatch problem, in which relevant documents might not contain terms that appear in the query. Thus, there have been efforts to substitute standard BOW approaches by learned (neural) rankers.

Pretrained language models (LMs) such as those based on Bidirectional Encoder Representations from Transformers (BERT) models are increasingly popular for natural language processing (NLP) and for re-ranking tasks in information retrieval. LM-based neural models have shown a strong ability to adapt to various tasks by simple fine-tuning. LM-based ranking models have provided improved results for passage re-ranking tasks. However, LM-based models introduce challenges of efficiency and scalability. Because of strict efficiency requirements, LM-based models conventionally have been used only as re-rankers in a two-stage ranking pipeline, while a first stage retrieval (or candidate generation) is conducted with BOW models that rely on inverted indexes.

There is a desire for retrieval methods in which most of the involved computation can be done offline and where online inference is fast. Learning dense embeddings to conduct retrieval using efficient approximate nearest neighbors (ANN) methods has shown good results, but such methods have still been combined with BOW models (e.g., combining both types of signals) due to their inability to explicitly model term matching.

There has been a growing interest in learning sparse representations for queries and documents. Using sparse representations, models can inherit desirable properties from BOW models such as exact-match of (possibly latent) terms, efficiency of inverted indexes, and interpretability. Additionally, by modeling implicit or explicit (latent, contextualized) expansion mechanisms, similarly to standard expansion models in IR, models can reduce vocabulary mismatch.

Dense retrieval based on BERT Siamese models is a standard approach for candidate generation in question answering and information retrieval tasks. An alternative to dense indexes is term-based ones. For instance, building on standard BOW models, Zamani et al. disclosed SNRM, in which a model embeds documents and queries in a sparse high-dimensional latent space using L1 regularization on representations. However, SNRM's effectiveness has remained limited.

More recently, there have been attempts to transfer knowledge from pretrained LMs to sparse approaches. For example, based on BERT, DeepCT (Dai and Callan, 2019, Context-Aware Sentence/Passage Term Importance Estimation For First Stage Retrieval, arXiv:1910.10687 [cs.IR]) focuses on learning contextualized term weights in the full vocabulary space, akin to BOW term weights. However, as the vocabulary associated with a document remains the same, this type of approach does not address vocabulary mismatch, as acknowledged by the use of query expansion for retrieval.

Another approach is to expand documents using generative methods to predict expansion words for documents. Document expansion adds new terms to documents, thus fighting the vocabulary mismatch, and repeats existing terms, implicitly performing reweighting by boosting important terms. Current methods, though, are limited by the way in which they are trained (predicting queries), which is indirect in nature and limits their progress.

Still another approach is to estimate the importance of each term of the vocabulary implied by each term of the document; that is, to compute an interaction matrix between the document or query tokens and all the tokens from the vocabulary. This can be followed by an aggregation mechanism that allows for the computation of an importance weight for each term of the vocabulary, for the full document or query. However, current methods either provide representations that are not sparse enough to provide fast retrieval, and/or they exhibit suboptimal performance.

### SUMMARY

Provided herein, among other things, are methods implemented by a computer having a processor and memory for providing a representation of an input sequence over a vocabulary in a ranker of a neural information retrieval model. The input sequence may be, for instance, a query or a document sequence. Each token of a tokenized input sequence is embedded based at least on the vocabulary to provide an embedded input sequence of tokens. The input sequence is tokenized using the vocabulary. An importance (e.g., weight) of each token over the vocabulary is predicted with respect to each token of the embedded input sequence. A predicted term importance of the input sequence as a representation of the input sequence over the vocabulary by performing an activation over the embedded input sequence. The embedding and the determining of a prediction are performed by a pretrained language model. The term importance is output as the representation of the input sequence over the vocabulary in the ranker of the neural information retrieval model.

Other embodiments provide, among other things, a neural model implemented by a computer having a processor and memory for providing a representation of an input sequence over a vocabulary in a ranker of a neural information retrieval model. The input sequence may be, for instance, a query or a document sequence. A pretrained language model layer is configured to embed each token in a tokenized input sequence based on the vocabulary and contextual features to provide context embedded tokens, and to predict an importance (e.g., weight) with respect to each token of the embedded input sequence over the vocabulary by transforming the context embedded tokens using one or more linear layers. The tokenized input sequence is tokenized using the vocabulary. A representation layer is configured to receive the predicted importance with respect to each token over the vocabulary and obtain a representation of importance (e.g., weight) of the input sequence over the vocabulary. The representation layer can comprise a concave activation layer configured to perform a concave activation of the predicted importance over the embedded input sequence. The representation layer may output the predicted term importance of the input sequence over the vocabulary in the ranker of the neural information retrieval model. The predicted term importance of the input sequence can be used to retrieve a document.

Other embodiments provide, among other things, a computer implemented method for training of a neural model for providing a representation of an input sequence over a vocabulary in a ranker of an information retrieval model. The training may be part of an end-to-end training of the ranker or the IR model. The neural model is provided with: i) a tokenizer layer configured to tokenize the input sequence using the vocabulary; ii) an input embedding layer configured to embed each token of the tokenized input sequence based at least on the vocabulary; iii) a predictor layer configured to predict an importance (e.g., weight) for each token of the input sequence over the vocabulary; and iv) a representation layer configured to receive the predicted importance with respect to each token over the vocabulary and obtain predicted importance (e.g., weight) of the input sequence over the vocabulary. The input embedding layer and the predictor layer may be embodied in a pretrained language model. The representation layer may comprise a concave activation layer configured to perform a concave activation of the predicted importance over the input sequence. In an example training method, parameters of the neural model are initialized, and the neural model is trained using a dataset comprising a plurality of documents. Training the neural model jointly optimizes a loss comprising a ranking loss and at least one sparse regularization loss. The ranking loss and/or the at least one sparse regularization loss can be weighted by a weighting parameter.

According to a complementary aspect, the present disclosure provides a computer program product, comprising code instructions to execute a method according to the previously described aspects; and a computer-readable medium, on which is stored a computer program product comprising code instructions for executing a method according to the previously described embodiments and aspects. The present disclosure further provides a processor configured using code instructions for executing a method according to the previously described embodiments and aspects.

Other features and advantages of the invention will be apparent from the following specification taken in conjunction with the following drawings.

### DESCRIPTION OF THE DRAWINGS

The accompanying drawings are incorporated into the specification for the purpose of explaining the principles of the embodiments. The drawings are not to be construed as limiting the invention to only the illustrated and described embodiments or to how they can be made and used. Further features and advantages will become apparent from the following and, more particularly, from the description of the embodiments as illustrated in the accompanying drawings, wherein:

FIG. 1 shows an example processor-based system for information retrieval (IR) of documents.

FIG. 2 shows an example processor-based method for providing a representation of an input sequence over a vocabulary.

FIG. 3 shows an example neural ranker model for performing the method of FIG. 2.

FIG. 4 shows an example method for comparing documents.

FIG. 5 shows an example training method for a neural ranking model.

FIG. 6 illustrates a tradeoff between effectiveness (MRR@10) and efficiency (FLOPS), when regularization weights for queries and documents are varied.

FIG. 7 shows example document and expansion terms.

FIG. 8 shows example performance versus FLOPS for various example models.

FIG. 9 shows an example architecture in which example methods can be implemented.

In the drawings, reference numbers may be reused to identify similar and/or identical elements.

### DETAILED DESCRIPTION

It is desirable to provide neural ranker models for ranking (e.g., document ranking) in information retrieval (IR) that can generate (vector) representations sparse enough to allow the use of inverted indexes for retrieval (which is faster and more reliable than methods such as approximate nearest neighbor (ANN) methods, and enables exact matching), while performing comparably to neural IR representations using dense embedding (e.g., in terms of performance metrics such as MRR (Mean Reciprocal Rank) and NDCG (Normalized Discounted Cumulative Gain)).

Example neural ranker models can combine rich term embeddings such as can be provided by trained language models (LMs) such as Bidirectional Encoder Representations from Transformers (BERT)-based LMs, with sparsity that allows efficient matching algorithms for IR based on inverted indexes. BERT-based language models are commonly used in natural language processing (NLP) tasks, and are exploited in example embodiments herein for ranking.

Example systems and methods can provide sparse representations (sparse vector representations or sparse lexical expansions) of an input sequence (e.g., a document or query) in the context of IR by predicting a term importance of the input sequence over a vocabulary. Such systems and methods can provide, among other things, expansion-aware representations of documents and queries.

An example pretrained LM, that is trained using a self-supervised pretraining objective, such as via masked language modeling (MLM) methods, can be used to determine a prediction of an importance (or weight) for an input sequence over the vocabulary (term importance) with respect to tokens of the input sequence. A final representation providing the predicted importance of the input sequence over the vocabulary can be obtained by performing an activation that includes a concave function to prevent some terms from dominating. Example concave activation functions can provide a log-saturation effect, while others can use functions such as radical functions (e.g., sqrt (1+x)).

Example neural ranker models can be further trained based in part on sparsity regularization to ensure sparsity of the produced representations and improve both the efficiency (computational speed) and the effectiveness (quality of lexical expansions) of first-stage ranking models. A trade-off between efficiency and effectiveness can be tailored using weights.

The concave activation and/or sparsity regularization can provide improvements over models such as those based on BERT architectures that require learned binary gating. Among other features, sparsity regularization may allow for end-to-end, single-stage training, without relying on handcrafted sparsification strategies such as BOW masking.

Neural ranking models may also be trained using in-batch negative sampling, in which some negative documents are included from other queries to provide a ranking loss that can be combined with sparsity regularization in an overall loss. By contrast, ranking models such as SparTerm (e.g., as disclosed in Bai et al., 2020. SparTerm: Learning Term based Sparse Representation for Fast Text Retrieval. arXiv:2010.00768 [cs.IR]), are trained using only hard negatives, e.g., generated by BM25. Training using in-batch negative sampling can further improve the performance of example models.

Experiments disclosed herein demonstrate that example neural ranking models, e.g., used for a first-stage ranker for information retrieval, can outperform other sparse retrieval methods on test datasets, yet can provide comparable results to state-of-the-art dense retrieval methods. Unlike dense retrieval approaches, example neural ranking models can learn sparse lexical expansions and thus can benefit from inverted index retrieval methods, avoiding the need for methods such as approximate nearest neighbor (ANN) search.

Example methods and systems herein can further provide training for a neural ranker model based on explicit sparsity regularization, which can be used in combination with a concave activation function for term weights. This can provide highly sparse representations and comparable results to existing dense and sparse methods. Example models can be implemented in a straightforward manner, and may be trained end-to-end in a single stage. The contribution of the sparsity regularization can be controlled in example methods to influence the trade-off between effectiveness and efficiency.

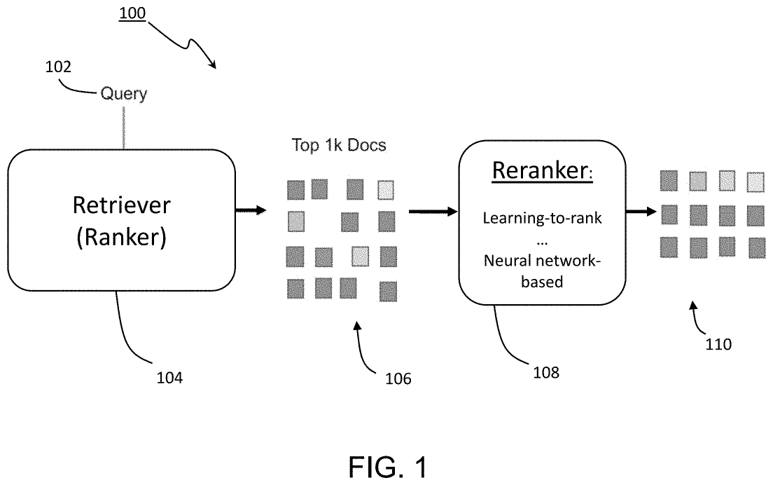

Referring now to the drawings, FIG. 1 shows an example system 100 using a neural model for information retrieval (IR) of documents, such as but not limited to a search engine. A query 102 is input to a first-stage retriever 104. Example queries include but are not limited to search requests or search terms for providing one or more documents (of any format), questions to be answered, items to be identified, etc. The first-stage retriever or ranker 104 processes the query 102 to provide a ranking of available documents, and retrieves a first set 106 of top-ranked documents. A second-stage or reranker 108 then reranks the retrieved set 106 of top-ranked documents and outputs a ranked set 110 of documents, which may be fewer in number than the first set 106.

Example neural ranker models according to embodiments herein may be used for providing rankings for the first-stage retriever or ranker 104, as shown in FIG. 1, in combination with a second-stage reranker 108. Example second-stage rerankers 108 include but are not limited to rerankers implementing learning-to-rank methods such as LambdaMart, RankNET, or GBDT on handcrafted features, or rerankers implementing neural network models with word embedding (e.g., word2vec). Neural network-based rerankers can be representation based, such as DSSM, or interaction based, such as DRMM, K-NRM, or DUET. In other example embodiments, example neural ranker models herein can alternatively or additionally provide rankings for the second stage reranker 108. In other embodiments, example neural ranker models can be used as a standalone ranking and possibly retrieval stage.

Example neural ranker models, whether used in the first-stage 104, the second stage 108, or as a standalone model, may provide representations, e.g., vector representations, of an input sequence over a vocabulary. The vocabulary may be predetermined. The input sequence can be embodied in, for instance, a query sequence such as the query 102, a document sequence to be ranked and/or retrieved based on a query, or any other input sequence. “Document” as used herein broadly refers to any sequence of tokens that can be represented in vector space and ranked using example methods and/or can be retrieved. A query broadly refers to any sequence of tokens that can be represented in vector space for use in ranking and retrieving one or more documents.

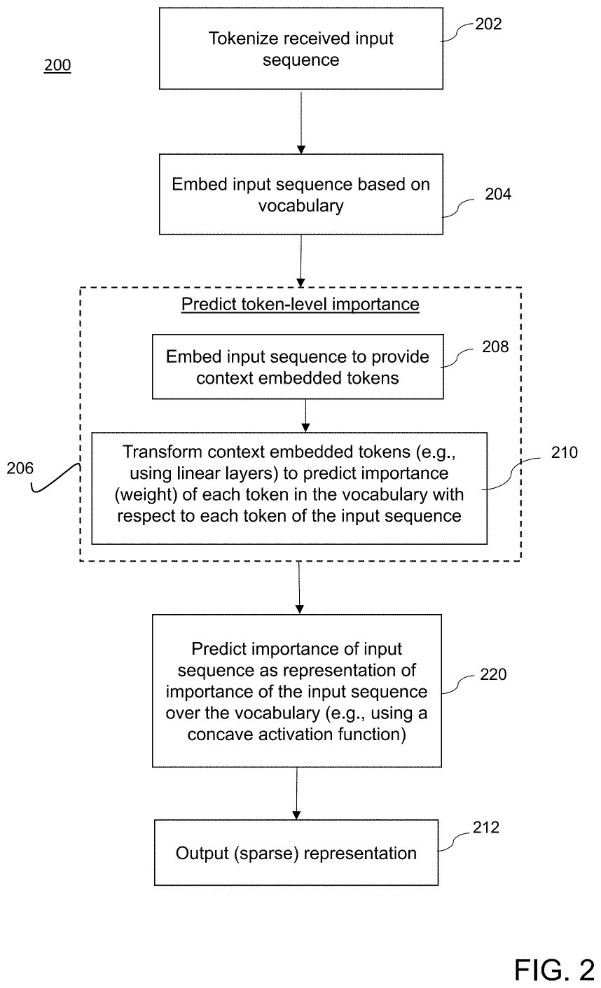

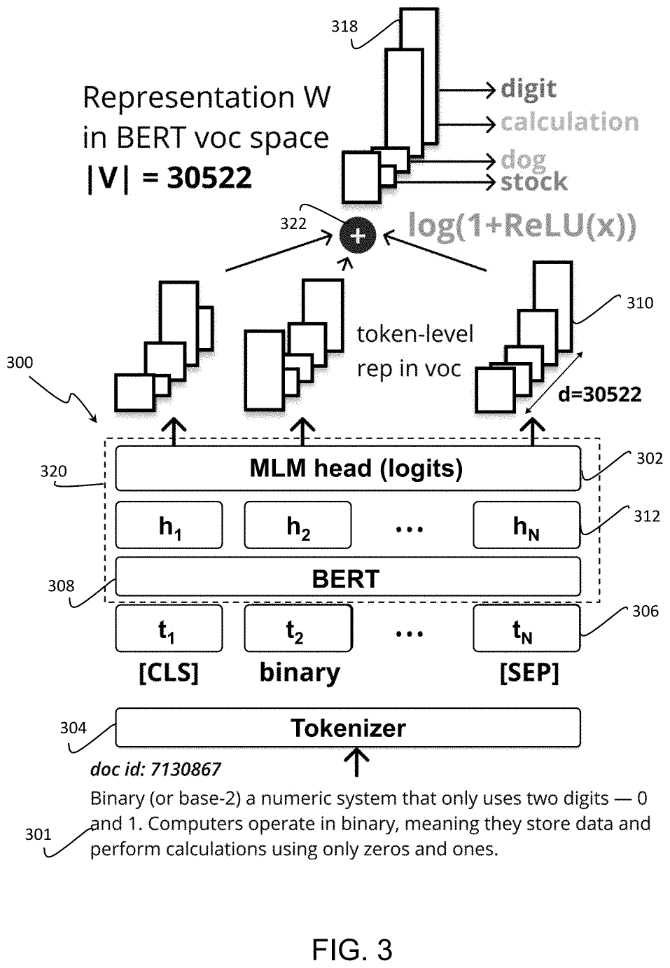

FIG. 2 shows an example method 200 for providing a representation of an input sequence over a predetermined vocabulary, a nonlimiting example being BERT WordPiece vocabulary (└V┘=30522), which representation may be used for ranking and/or reranking in IR. FIG. 3 shows an example neural ranker model 300 that may be used for performing the method 200. The neural ranker model 300 can be implemented by one or more computers having at least one processor and one memory.

Example neural ranker models herein can infer sparse representations for input sequences, e.g., queries or documents, directly by providing supervised query and/or document expansion. Example models can perform expansion using a pretrained language model (LM) such as but not limited to an LM trained using unsupervised methods such as Masked Language Model (MLM) training methods. For instance, a neural ranker model can perform expansion based on the log its (i.e., unnormalized outputs) 302 of a Masked Language Model (MLM)-trained LM 320. Regularization may be used to train example retrievers to ensure or encourage sparsity.

An example pretrained LM may be based on BERT. BERT, e.g., as disclosed in Devlin et al, 2019, BERT: Pre-training of Deep Bidirectional Transformers for Language Understanding, CoRR abs/1810.04805, incorporated herein by reference, is a family of transformer-based training methods and associated models, which may be pre-trained on two tasks: masked-token prediction, referred to as a “masked language model” (MLM) task”; and next-sentence prediction. These models are bidirectional in that each token attends to both its left and right neighbors, not only to its predecessors. Example neural ranker models herein can exploit pretrained language model such as those provided by BERT-based models to project token-level importance over a vocabulary (such as over a BERT vocabulary space, or other vocabulary space) for an input sequence, and then obtain predicted importance of the input sequence over the vocabulary to provide a representation of the input sequence.

The input sequence 301 received by the neural ranker model 300 is tokenized at 202 by a tokenizer layer 304 using the predetermined vocabulary (in this example, a BERT vocabulary) to provide a tokenized input sequence t₁ . . . t_{N} 306. The tokenized input sequence 306 may also include one or more special tokens, such as but not limited to <CLS> (a symbol added in front of an input sequence, which may be used in some BERT methods for classification) and/or <SEP> (used in some BERT methods for a separator), as can be used in BERT embeddings.

Token-level importance is predicted at 206. Token-level importance refers to an importance (or weight, or representation) of each token in the vocabulary, with respect to each token of the input sequence (e.g., a “local” importance). For example, each token of the tokenized input sequence 306 may be embedded at 208 to provide a sequence of context-embedded tokens h₁ . . . h_{N} 312. The embedding of each token of the tokenized input sequence 306 may be based on, for instance, the vocabulary and the token's position within the input sequence. The context embedded tokens h₁ . . . h_{N} 312 may represent contextual features of the tokens within the embedded input sequence. An example context embedding 208 may use one or more embedding layers embodied in transformer-based layers such as BERT layers 308 of the pretrained LM 320.

Token-level importance of the input sequence is predicted over the vocabulary (e.g., BERT vocabulary space) at 210 from the context-embedded tokens 312. A token-level importance distribution layer, e.g., embodied in a head (log its) 302 of the pretrained LM 320 (e.g., trained using MLM methods) may be used to predict an importance (or weight) of each token of the vocabulary with respect to each token of the input sequence of tokens; that is, a (input sequence) token-level or local representation 310 in the vocabulary space. For instance, the MLM head 302 may transform the context embedded tokens 312 using one or more linear layers, each including at least one log it function, to predict an importance (e.g., weight, or other representation) of each token in the vocabulary with respect to each token of the embedded input sequence and provide the token-level representation 310 in the vocabulary space.

For example, consider an input query or document sequence after tokenization 202 (e.g., WordPiece tokenization) t=(t₁, t₂, . . . t_{N}), and its corresponding BERT embeddings (or BERT-like model embeddings) after embedding 208 (h₁, h₂, . . . h_{N}). The importance wᵢⱼ of the token j (vocabulary) for a token i (of the input sequence) can be provided at step 210 by:

wᵢⱼ=transform(hᵢ)^{T}Eⱼ+bⱼ j∈{1, . . . └V┘} (1)

where Eⱼ denotes the BERT (or BERT-like model) input embedding resulting from the tokenizer and the model parameter for token j (i.e., a vector representing token j without taking into account the context), bⱼ is a token-level bias, and transform(.) is a linear layer with Gaussian error linear unit (GeLU) activation, e.g., as disclosed in Hendrycks and Gimpel, arXiv:1606.08415, 2016, and a normalization layer LayerNorm. GeLU can be provided, for instance, by x [symbol] xϕ(x), or can be approximated in terms of the tan h(·) function (as the variance of the Gaussian goes to zero one arrives at a rectified linear unit (ReLU), but for unit variance one gets GeLU). T can correspond to the transpose operation in linear algebra, e.g., to indicate that in the end it is a dot product, and may be included in the transform function.

Equation (1) can be equivalent to the MLM prediction. Thus, it can also be initialized, for instance, from a pretrained MLM model (or other pretrained LM).

Term importance of the input sequence 318 (e.g., a global term importance for the input sequence) is predicted at 220 as a representation of importance (e.g., weight) of the input sequence over the vocabulary by performing an activation using a representation layer 322 that performs a concave activation function over the embedded input sequence. The predicted term importance of the input sequence predicted at 220 may be independent of the length of the input sequence. The concave activation function can be, as nonlimiting examples, a logarithmic activation function or a radical function (e.g., a sqrt (1+x) function; a mapping w→({square root over ((1+ReLU(w)))}−1)^{k} for an appropriate scaling k, etc.).

For instance, the final representation of importance of the input sequence 318 can be obtained by combining (or maximizing, for example) importance predictors over the input sequence tokens, and applying a concave function such as a logarithmic function after applying an activation function such as ReLU to ensure the positivity of term weights:

$${w}_{j} = {max}_{i ∈ t} log ( 1 + Re LU ( {w}_{i j} ) ) \qquad ( 2 )$$

The above example model provides a log-saturation effect that prevents some terms from dominating and (naturally) ensures sparsity in representations. Logarithmic activation has been used, for instance, in computer vision, e.g., as disclosed in Yang Liu et al., Natural-Logarithm-Rectified Activation Function in Convolutional Neural Networks, arXiv, 2019, 1908.03682. While using a log-saturation or other concave functions prevents some terms from dominating, surprisingly the implied sparsity obtains improved results and allows obtaining of sparse solutions without regularization.

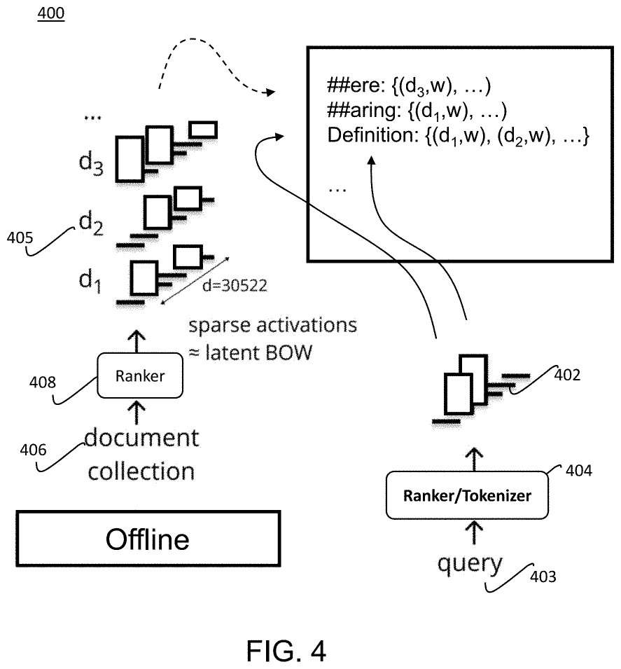

The final representation (i.e., the predicted term importance of the input sequence), output at 212, may be compared to representations from other sequences, including queries or documents, or, since the representations are in the vocabulary space, simply to tokenizations of sequences (e.g., a tokenization of a query over the vocabulary can provide a representation). FIG. 4 shows an example comparison method 400. The representation 402 of a query 403, e.g., generated by a ranker/tokenizer 404 such as provided by the neural ranker model 300 or by a tokenizer, is compared to representations of each of a plurality of candidate sequences 405, e.g., generated offline for a document collection 406 by a neural ranker model (Ranker) 408 such as the neural ranker model 300. The candidate sequences 405 may be respectively associated with candidate documents (or themselves are candidate documents) for information retrieval. An example comparison may include, for instance, taking a dot product between the representations. This comparison may provide a ranking score. The plurality of candidate sequences 405 can then be ranked based on the ranking score, and a subset of the documents 406 (e.g., the highest ranked set, a sampled set based on the ranking, etc.) can be retrieved. This retrieval can be performed during the first (ranking) and/or the second stage (reranking) of an information retrieval method.

An example training method for the neural ranker model 300 will now be described. Generally, training begins by initializing parameters of the model, e.g., weights and biases, which are then iteratively adjusted after evaluating an output result produced by the model for a given input against the expected output. To train the neural ranker model 300, parameters of the neural model can be initialized. Some parameters may be pretrained, such as but not limited to parameters of a pretrained LM such as an MLM. Initial parameters may additionally or alternatively be, for example, randomized, or initialized in any other suitable manner. The neural ranker model 300 may be trained using a dataset including a plurality of documents. The dataset may be used in batches to train the neural ranker model 300. The dataset may include a plurality of documents including a plurality of queries. For each of the queries the dataset may further include at least one positive document (a document associated with the query) and at least one negative document (a document not associated with the query). Negative documents can include hard negative documents, which are not associated with any of the queries in the dataset (or in the respective batch), and/or negative documents that are not associated with the particular query but are associated with other queries in the dataset (or batch). Hard documents may be generated, for instance, by sampling a model such as but not limited to a ranking model.

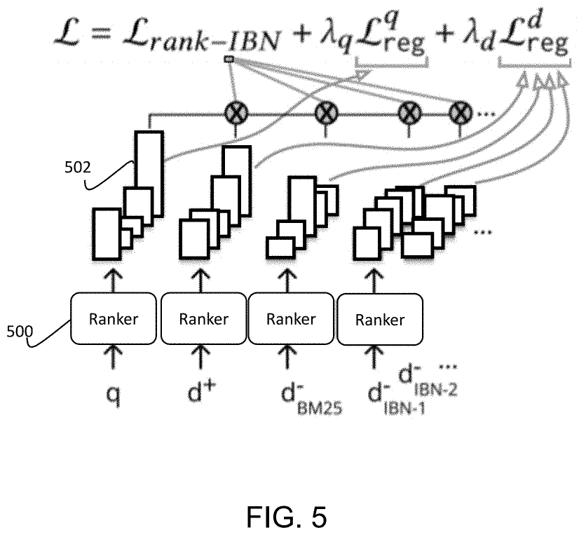

FIG. 5 shows an example training method for a neural ranking model 500, such as the neural ranker model 300 (shown in FIG. 3), employing an in-batch negatives (IBN) sampling strategy. Let s(q,d) denote the ranking score obtained from dot product between q and d representations 502 from Equation (2). Given a query qᵢ in a batch, a positive document dᵢ⁺, a (hard) negative document dᵢ⁻ (e.g., coming from sampling a ranking function, e.g., from BM25 sampling), and a set of negative documents in the batch provided by positive documents from other queries {d_{i,j}⁻}ⱼ, the ranking loss can be interpreted as the maximization of the probability of the document dᵢ⁺ being relevant among the documents dᵢ⁺, dᵢ⁻, and {d_{i,j}⁻}ⱼ:

$${ℒ}_{r a nk - IBN} = - log \frac{{e}^{s ( {q}_{i} , {d}_{i}^{+} )}}{{e}^{s ( {q}_{i} , {d}_{i}^{+} )} + {e}^{s ( {q}_{i} , {d}_{i}^{-} )} + {\sum }_{j} {e}^{s ( {q}_{i} {d}_{i , j}^{-} )}} \qquad ( 3 )$$

The example neural ranker model 500 can be trained by minimizing the loss in Equation (3).

Additionally, the ranking loss may be supplemented to provide for sparsity regularization. Learning sparse representations has been employed in methods such as SNRM (e.g., Zamani et al., 2018, from Neural Re-Ranking to Neural Ranking: Learning a Sparse Representation of Inverted Indexing, In Proceedings of the 27th ACM International Conference on Information and Knowledge Management (Torino, Italy) (CIKM '18). Association for Computing Machinery, New York, N.Y., USA, 497-506) via [symbol] ₁ regularization. However, minimizing the [symbol] ₁ norm of representations does not result in the most efficient index, as nothing ensures that posting lists are evenly distributed. This is even truer for standard indexes due to the Zipfian nature of the term frequency distribution.

To obtain a well-balanced index, Paria et al., 2020, Minimizing FLOPs to Learn Efficient Sparse Representations, arXiv:2004.05665, discloses the FLOPS regularizer, a smooth relaxation of the average number of floating-point operations necessary to compute the score of a document, and hence directly related to the retrieval time. It is defined using aⱼ as a continuous relaxation of the activation (i.e., the term has a non-zero weight) probability pⱼ for token j, and estimated for documents d in a batch of size N by

$${\overline{a}}_{j} = \frac{1}{N} {\sum }_{i = 1}^{N} {w}_{j}^{( {d}_{i} )} .$$

This provides the following regularization loss:

$${ℓ}_{F L O P S} = {\sum }_{j ∈ V} {\overline{a}}_{j}^{2} = {\sum }_{j ∈ V} {( \frac{1}{N} {\sum }_{i = 1}^{N} {w}_{j}^{( {d}_{i} )} )}^{2}$$

This differs from the [symbol] ₁ regularization used in SNRM in that the āⱼ are not squared: using [symbol] _{FLOPS} thus pushes down high average term weight values, giving rise to a more balanced index.

Example models may combine one or more of the above features to provide training, e.g., end-to-end training, of sparse, expansion-aware representations of documents and queries. For instance, example models can learn the log-saturation model provided by Equation (2) by jointly optimizing ranking and regularization losses:

[symbol]

= [symbol] _{rank-IBN}+λ_{q} [symbol] _{reg}^{q}+λ_{d} [symbol] _{reg}^{d} (4)

In Equation (4), [symbol] _{reg} is a sparse regularization (e.g., [symbol] ₁ or [symbol] _{FLOPS}). Two distinct regularization weights (λ_{q} and λ_{d}) for queries and documents, respectively, can be provided in the example loss function, allowing additional pressure to be put on the sparsity for queries, which is highly useful for fast retrieval.

Neural ranker models may also employ pooling methods to further enhance effectiveness and/or efficiency. For instance, by straightforwardly modifying the pooling mechanism disclosed above, example models may increase effectiveness by a significant margin.

An example max pooling method may change the sum in Equation (2) above by a max pooling operation:

$${w}_{j} = {max}_{i ∈ t} log ( 1 + Re LU ( {w}_{i j} ) ) \qquad ( 5 )$$

This modification can provide improved performance, as demonstrated in experiments.

Example models can also be extended without query expansion, providing a document-only method. Such models can be inherently more efficient, as everything can then be pre-computed and indexed offline, while providing results that remain competitive. Such methods can be provided in combination with the max pooling operation or separately. In such methods, there are no query expansions nor term weighting, and thus the ranking score can be provided simply by comparing a tokenization of the query in the vocabulary to (e.g., pre-computed) representations of documents that can be generated by the neural ranker model:

s(q,d)=Σ_{j∈q}wⱼ^{d} (6)

Another example modification may incorporate distillation into training methods. Distillation can be provided in combination with any of the above example models or training methods or provided separately. An example distillation may be based on methods disclosed in Hofstatter et al., Improving Efficient Neural Ranking Models with Cross-Architecture Knowledge Distillation, arXiv:2010.02666, 2020. Distillation techniques can be used to further boost example model performance, as demonstrated by experiments showing near state-of-the-art performance on MS MARCO passage ranking tasks as well as the BEIR zero-shot benchmark.

Example distillation training can include at least two steps. In a first step, both a first stage retriever, e.g., as disclosed herein, and a reranker, such as those disclosed herein (as a nonlimiting example, HuggingFace, as provided by https://huggingface.co/cross-encoder/ms-marco-MiniLM-L-12-v2) are trained using triplets (e.g., a query q, a relevant passage p⁺, and a non-relevant passage p⁻), e.g., as disclosed in Hofstatter et al., 2020, Improving Efficient Neural Ranking Models with Cross-Architecture Knowledge Distillation. arXiv:2010.02666. In a second step, triplets are generated with harder negatives using an example model trained with distillation, and the reranker is used to generate the desired scores.

A model, an example of which is referred to in experiments herein as SPLADEₘₐₓ, may then be trained from scratch using these triplets and scores. The result of this second step provides a distilled model, an example of which is referred to in experiments herein as DistilSPLADEₘₐₓ.

### Experiments

In a first set of experiments, example models were trained and evaluated on the MS MARCO passage ranking dataset (https://github.com/microsoft/MSMARCO-Passage-Ranking) in the full ranking setting. This dataset contains approximately 8.8M passages, and hundreds of thousands of training queries with shallow annotation 1.1 relevant passages per query on average). The development set contained 6980 queries with similar labels, while the TREC DL 2019 evaluation set provides fine-grained annotations from human assessors for a set of 43 queries.

Training, indexing, and retrieval: The models were initialized with the BERT-based checkpoint. Models were trained with the ADAM optimizer, using a learning rate of 2e⁻⁵ with linear scheduling and a warmup of 6000 steps, and a batch size of 124. The best checkpoint was kept using MRR@10 on a validation set of 500 queries, after training for 150 k iterations. Though experiments were validated on a re-ranking task, other validation may be used in example methods. A maximum length of 256 was considered for input sequences.

To mitigate the contribution of the regularizer at the early stages of training, the method disclosed in Paria et al., 2020, was followed, using a scheduler for λ, quadratically increasing 2 L at each training iteration, until a given step (in experiments, 50 k), from which it remained constant. Typical values for 2 L fall between 1e⁻¹ and 1e⁻⁴. For storing the index, a custom implementation was used based on Python arrays. Numba was relied on for parallelizing retrieval. Models were trained using PyTorch and HuggingFace transformers, using 4 Tesla V100 GPUs with 32 GB memory.

Evaluation: Recall@1000 was evaluated for both datasets, as well as the official metrics MRR@10 and NDCG@10 for MS MARCO dev set and TREC DL 2019 respectively. Since the focus of the evaluation was on the first retrieval step, re-rankers based on BERT were not considered, and example methods were compared to first stage rankers only. Example methods were compared to the following sparse approaches: 1) BM25; 2) DeepCT; 3) doc2query-T5 (Nogueira and Lin, 2019. From doc2query to docTTTTTquery); and 4) SparTerm, as well as known dense approaches ANCE (Xiong et al., 2020, Approximate Nearest Neighbor Negative Contrastive Learning for Dense Text Retrieval, arXiv:2007.00808 [cs.IR]) and TCT-ColBERT (Lin et al., 2020, Distilling Dense Representations for Ranking using Tightly-Coupled Teachers. arXiv:2010.11386 [cs.IR]). Results were provided from the original disclosures for each approach. A pure lexical SparTerm trained with an example ranking pipeline (ST lexical-only) was included. To illustrate benefits of log-saturation, results were added for models trained using binary gating (wⱼ=gⱼ×Σ_{i∈t} ReLU(wᵢⱼ), where gⱼ is a binary mask) instead of using Equation (2) above (ST exp- [symbol] ₁ and ST exp- [symbol] _{FLOPS}) For sparse models, an estimate was indicated of the average number of floating-point operations between a query and a document in Table 1, when available, which was defined as the expectation [symbol] _{q,d} [Σ_{j∈V} pⱼ^{(q)}pⱼ^{(d)}] where pⱼ is the activation probability for token j in a document d or a query q. It was empirically estimated from a set of approximately 100 k development queries, on the MS MARCO collection.

Results are shown in Table 1, below. Overall, it was observed that example models outperformed the other sparse retrieval methods by a large margin (except for recall@1000 on TREC DL), and that the results were competitive with current dense retrieval methods.

For instance, example methods for ST lexical-only outperformed the results of DeepCT as well as previously-reported results for SparTerm—including the model using expansion. Because of the additional sparse expansion mechanism, results could be obtained that were comparable to current state-of-the-art dense approaches on MS MARCO dev set (e.g., Recall@1000 close to 0.96 for ST exp- [symbol] ₁), but with a much larger average number of FLOPS.

By adding a log-saturation effect to the expansion model, example methods greatly increased sparsity, reducing the FLOPS to similar levels than BOW approaches, at no cost to performance when compared to the best first-stage rankers. In addition, an advantage was observed for the FLOPS regularization over [symbol] ₁ in order to decrease the computing cost. In contrast to SparTerm, example methods were trained end-to-end in a single step. Example methods were also more straightforward compared to dense baselines such as ANCE, and they avoid resorting to approximate nearest neighbors search.

TABLE 1
Evaluation on MS MARCO passage retrieval
(dev set) and TREC DL 2019

| | MS MARCO dev | | TREC DL 2019 | |
|---|---|---|---|---|
| model | MRR@10 | R@1000 | NDCG@10 | R@1000 |

Dense retrieval

| | | | | |
|---|---|---|---|---|
| Siamese (ours) | 0.312 | 0.941 | 0.637 | 0.711 |
| ANCE [30] | 0.330 | 0.959 | 0.648 | — |
| TCT-CoIBERT [17] | 0.359 | 0.970 | 0.719 | 0.760 |
| TAS-B [11] | 0.347 | 0.978 | 0.717 | 0.843 |
| RocketQA [25] | 0.370 | 0.979 | — | — |

Sparse retrieval

| | | | | |
|---|---|---|---|---|
| BM25 | 0.184 | 0.853 | 0.506 | 0.745 |
| DeepCT [4] | 0.243 | 0.913 | 0.551 | 0.756 |
| doc2query-T5 [21] | 0.277 | 0.947 | 0.642 | 0.827 |
| COIL-tok [9] | 0.341 | 0.949 | 0.660 | — |
| DeepImpact [19] | 0.326 | 0.948 | 0.695 | — |
| SPLADE [8] | 0.322 | 0.955 | 0.665 | 0.813 |

Our methods

| | | | | |
|---|---|---|---|---|
| SPLADEₘₐₓ | 0.340 | 0.965 | 0.684 | 0.851 |
| SPLADE-doc | 0.322 | 0.946 | 0.667 | 0.747 |
| DistilSPLADEₘₐₓ | 0.368 | 0.979 | 0.729 | 0.865 |

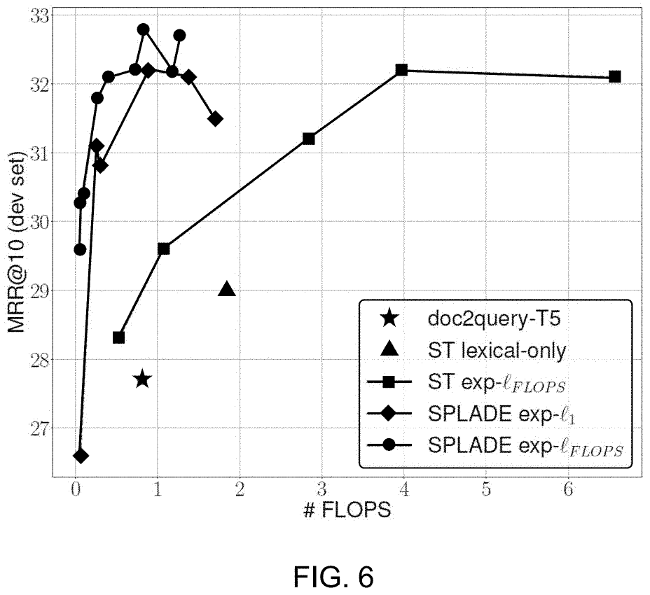

FIG. 6 illustrates a tradeoff between effectiveness (MRR@10) and efficiency (FLOPS), when λ_{q} and λ_{d} are varied (varying both implies that plots are not smooth). It was observed that ST exp- [symbol] _{FLOPS} falls far below BOW models and example methods in terms of efficiency. In the meantime, example methods (SPLADE exp- [symbol] ₁, SPLADE exp- [symbol] _{FLOPS}) reached efficiency levels equivalent to sparse BOW models, while outperforming doc2query-T5. Strongly regularized models had competitive performance (e.g., FLOPS=0.05, MRR@10=0.0296). Further, the regularization effect brought by [symbol] _{FLOPS} compared to [symbol] ₁ was apparent: for the same level of efficiency, performance of the latter was always lower.

The experiments demonstrated that the expansion provides improvements with respect to the purely lexical approach by increasing recall. Additionally, representations obtained from expansion-regularized models were sparser: the models learned how to balance expansion and compression, by both turning off irrelevant dimensions and activating useful ones. On a set of 10 k documents, the SPLADE- [symbol] _{FLOPS} results from Table 1 dropped on average 20 terms per document, while adding 32 expansion terms. For one of the most efficient models (FLOPS=0.05), 34 terms were dropped on average, with only 5 new expansion terms. In this case, representations were extremely sparse: documents and queries contained on average 18 and 6 non-zero values respectively, and less than 1.4 GB was required to store the index on disk.

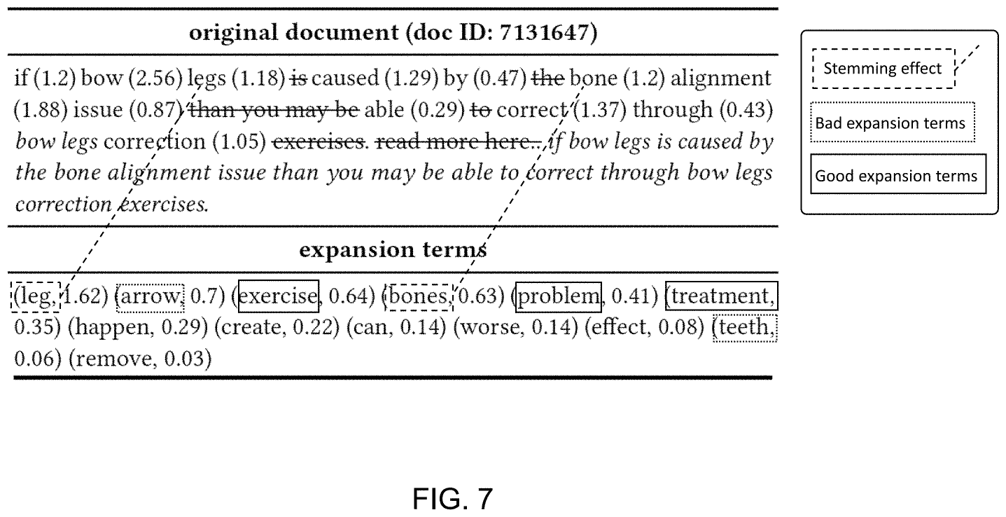

FIG. 7 shows example document and expansion terms. The figure shows an example operation where the example neural model performed term re-weighting by emphasizing important terms and discarding terms without information content (e.g., is). In FIG. 7 the weight associated with the term is shown between parenthesis (omitted for the second occurrence of the term in the document). Strike-throughs are shown for zeros. Expansion provides enrichment of the example document, either by implicitly adding stemming effects (e.g., legs→leg) or by adding relevant topic words (e.g., treatment).

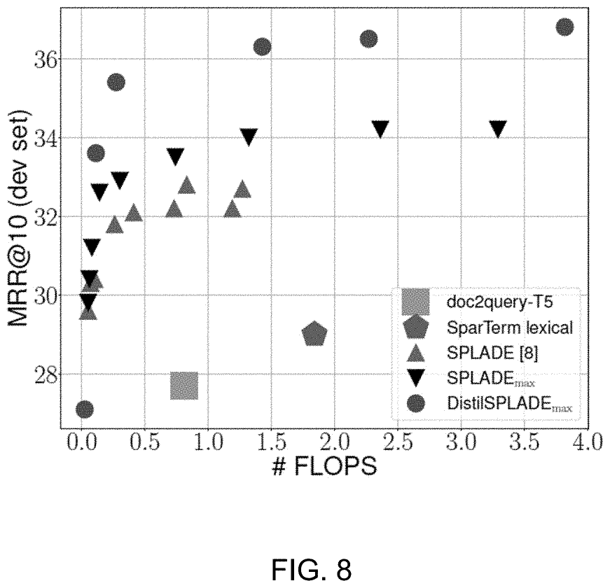

Additional experiments were performed using the example max pooling, document encoding, and distillation features described above, and using the MS MARCO dataset. Table 2 below shows example results for MS-MARCO and TREC-2019 as in Table 1 above, as further compared to results of further experiments using modified models. FIG. 8, similar to FIG. 6, shows example performance versus FLOPS for various example models, including example modified models, trained with different regularization strength.

TABLE 2
Evaluation on MS MARCO passage retrieval (dev set) and
TREC DL 2019 (with comparison to additional models)

| | MS MARCO dev | | TREC DL 2019 | |
|---|---|---|---|---|
| model | MRR@10 | R@1000 | NDCG@10 | R@1000 |

Dense retrieval

| | | | | |
|---|---|---|---|---|
| Siamese (ours) | 0.312 | 0.941 | 0.637 | 0.711 |
| ANCE [30] | 0.330 | 0.959 | 0.648 | — |
| TCT-CoIBERT [17] | 0.359 | 0.970 | 0.719 | 0.760 |
| TAS-B [11] | 0.347 | 0.978 | 0.717 | 0.843 |
| RocketQA [25] | 0.370 | 0.979 | — | — |

Sparse retrieval

| | | | | |
|---|---|---|---|---|
| BM25 | 0.184 | 0.853 | 0.506 | 0.745 |
| DeepCT [4] | 0.243 | 0.913 | 0.551 | 0.756 |
| doc2query-T5 [21] | 0.277 | 0.947 | 0.642 | 0.827 |
| COIL-tok [9] | 0.341 | 0.949 | 0.660 | — |
| DeepImpact [19] | 0.326 | 0.948 | 0.695 | — |
| SPLADE [8] | 0.322 | 0.955 | 0.665 | 0.813 |

Our methods

| | | | | |
|---|---|---|---|---|
| SPLADEₘₐₓ | 0.340 | 0.965 | 0.684 | 0.851 |
| SPLADE-doc | 0.322 | 0.946 | 0.667 | 0.747 |
| DistilSPLADEₘₐₓ | 0.368 | 0.979 | 0.729 | 0.865 |

The zero-shot performance of example models was verified using a subset of datasets from the BEIR benchmark (e.g., as disclosed in Thakur et al., BEIR: A Heterogenous Benchmark for Zero-shot Evaluation of Information Retrieval Models, CoRR abs/2104.08663 (2021), arXiv:2104.08663), which encompasses various IR datasets for zero shot comparison. A subset was used due to the fact that some of the datasets were not readily available.

Comparison was made to the best performing models from Thakur et al., 2021 (ColBERT (Khattab and Zaharia, 2020, ColBERT: Efficient and Effective Passage Search via Contextualized Late Interaction over BERT, In Proceedings of the 43^{rd} International ACM SIGIR Conference on Research and Development in Information Retrieval (Virtual Event, China) (SIGIR '20). Association for Computing Machinery, New York, N.Y., USA, 39-48)) and the two best performing from the rolling benchmark (tuned BM25 and TAS-B). Table 3, below, shows additional results from example models against several baselines on the BEIR benchmark. Generally, it was observed that example models outperformed the other sparse retrieval methods by a large margin (except for recall@1000 on TREC DL), and that results were competitive with state-of-the-art dense retrieval methods.

TABLE 3
NDCG@10 results on BEIR

| | Baselines | | | Splade | | |
|---|---|---|---|---|---|---|
| Corpus | Colbert | BM25 | TAS-B | Sum | Max | Distil |
| MSMARCO | 0.425 | 0.228 | 0.408 | 0.387 | 0.402 | 0.433 |
| arguana | 0.233 | 0.315 | 0.427 | 0.447 | 0.439 | 0.479 |
| climate-fever | 0.184 | 0.213 | 0.228 | 0.162 | 0.199 | 0.235 |
| DBPedia | 0.392 | 0.273 | 0.384 | 0.343 | 0.366 | 0.435 |
| fever | 0.771 | 0.753 | 0.700 | 0.728 | 0.730 | 0.786 |
| fiqa | 0.317 | 0.236 | 0.300 | 0.258 | 0.287 | 0.336 |
| hotpotqa | 0.593 | 0.603 | 0.584 | 0.635 | 0.636 | 0.684 |
| nfcorpus | 0.305 | 0.325 | 0.319 | 0.311 | 0.313 | 0.334 |
| nq | 0.524 | 0.329 | 0.463 | 0.438 | 0.469 | 0.521 |
| quora | 0.854 | 0.789 | 0.835 | 0.829 | 0.835 | 0.838 |
| scidocs | 0.145 | 0.158 | 0.149 | 0.141 | 0.145 | 0.158 |
| scifact | 0.671 | 0.665 | 0.643 | 0.626 | 0.628 | 0.693 |
| tree-covid | 0.677 | 0.656 | 0.481 | 0.655 | 0.673 | 0.710 |
| webis-touche2020 | 0.275 | 0.614 | 0.173 | 0.289 | 0.316 | 0.364 |
| Average all | 0.455 | 0.440 | 0.435 | 0.446 | 0.460 | 0.500 |
| Average zero shot | 0.457 | 0.456 | 0.437 | 0.451 | 0.464 | 0.506 |
| Best on dataset | 2 | 2 | 0 | 0 | 0 | 11 |

TABLE 4
Recall@100 results on BEIR

| | Baselines (from BEIR) | | | Splade | | |
|---|---|---|---|---|---|---|
| Corpus | Colbert | BM25 | TAS-B | Sum | Max | Distil |
| MSMARCO | 86.5% | 65.8% | 88.4% | 84.9% | 87.1% | 89.8% |
| arguana | 46.4% | 94.2% | 94.2% | 94.5% | 94.6% | 97.2% |
| climate-fever | 64.5% | 43.6% | 53.4% | 36.8% | 45.3% | 52.4% |
| DBPedia | 46.1% | 39.8% | 49.9% | 45.3% | 49.5% | 57.5% |
| fever | 93.4% | 93.1% | 93.7% | 93.3% | 93.5% | 95.1% |
| fiqa | 60.3% | 54.0% | 59.3% | 53.8% | 57.2% | 62.1% |
| hotpotqa | 74.8% | 74.0% | 72.8% | 76.8% | 78.1% | 82.03% |
| nfcorpus | 25.4% | 25.0% | 29.4% | 25.6% | 26.5% | 27.7% |
| nq | 91.2% | 76.0% | 90.3% | 84.4% | 87.5% | 93.1% |
| quora | 98.9% | 97.3% | 98.6% | 98.4% | 98.4% | 98.7% |
| scidocs | 34.4% | 35.6% | 33.5% | 32.8% | 34.9% | 36.4% |
| scifact | 87.8% | 90.8% | 89.1% | 88.4% | 89.8% | 92.0% |
| tree-covid | 46.4% | 49.8% | 38.7% | 48.6% | 50.2% | 55.0% |
| webis-touche2020 | 30.9% | 45.8% | 26.4% | 31.3% | 33.1% | 35.4% |
| Average all | 63.4% | 63.2% | 65.6% | 63.9% | 66.1% | 69.6% |
| Average zero shot | 61.6% | 63.0% | 63.8% | 62.3% | 64.5% | 68.1% |
| Best on dataset | 2 | 1 | 1 | 0 | 0 | 10 |

Impact of Max Pooling: On MS MARCO and TREC, models including max pooling (SPLADEₘₐₓ) brought almost 2 points in MRR and NDCG compared to example models without max pooling (SPLADE). Such models are competitive with models such as COIL and DeepImpact. FIG. 8 shows performance versus FLOPS for experimental models trained with different regularization strength 2L on the MS MARCO dataset. FIG. 8 shows that SPLADEₘₐₓ performed better than SPLADE and that the efficiency versus sparsity trade-off can also be adjusted. Also, SPLADEₘₐₓ demonstrated improved performance on the BEIR benchmark (Table 3—NDCG@10 results; Table 4—Recall@100 results).

The example document encoder with max pooling (SPLADEₘₐₓ) was able to reach the same performance as the above model (SPLADE), outperforming doc2query-T5 on MS MARCO. As this model had no query encoder, it had better latency. Further, this example document encoder is straightforward to train and to apply to a new document collection: a single forward is required, as opposed to multiple inference with beam search for methods such as doc2query-T5.

Impact of Distillation: Adding distillation significantly improved the performance of the example SPLADE model, as shown by example model in Table 2 (DistilSPLADEₘₐₓ). FIG. 8 shows effectiveness/efficiency trade-off analysis. Generally, example distilled models provided further improvements for higher values of flops (0.368 MRR with 4 flops), but were still very efficient in low regime (0.35 MRR with 0.3 flops). Further, the example distilled model (DistilSPLADEₘₐₓ) was able to outperform all other experimental methods in most datasets. Without wishing to be bound by theory, it is believed that advantages of example models are due at least in part to the fact that embeddings provided by example models transfer better because they use tokens that have intrinsic meaning compared to dense vectors.

Network Architecture

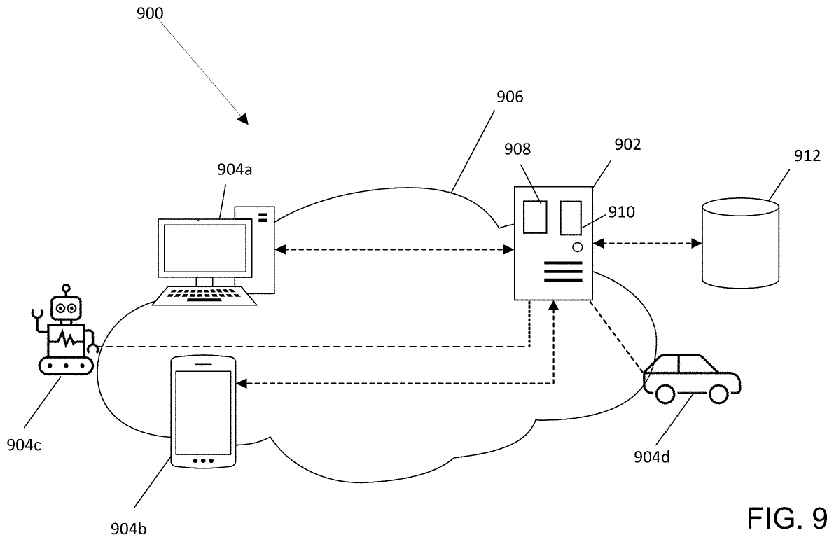

Example systems, methods, and embodiments may be implemented within a network architecture 900 such as illustrated in FIG. 9, which comprises a server 902 and one or more client devices 904 that communicate over a network 906 which may be wireless and/or wired, such as the Internet, for data exchange. The server 902 and the client devices 904a, 904b can each include a processor, e.g., processor 908 and a memory, e.g., memory 910 (shown by example in server 902), such as but not limited to random-access memory (RAM), read-only memory (ROM), hard disks, solid state disks, or other non-volatile storage media. Memory 910 may also be provided in whole or in part by external storage in communication with the processor 908.

The system 100 (shown in FIG. 1) and/or the neural ranker model 300, 408, 500 (shown in FIGS. 3, 4, and 5, respectively) for instance, may be embodied in the server 902 and/or client devices 904. It will be appreciated that the processor 908 can include either a single processor or multiple processors operating in series or in parallel, and that the memory 910 can include one or more memories, including combinations of memory types and/or locations. Server 902 may also include, but are not limited to, dedicated servers, cloud-based servers, or a combination (e.g., shared). Storage, e.g., a database, may be embodied in suitable storage in the server 902, client device 904, a connected remote storage 912 (shown in connection with the server 902, but can likewise be connected to client devices), or any combination.

Client devices 904 may be any processor-based device, terminal, etc., and/or may be embodied in a client application executable by a processor-based device, etc. Client devices may be disposed within the server 902 and/or external to the server (local or remote, or any combination) and in communication with the server. Example client devices 904 include, but are not limited to, autonomous computers 904a, mobile communication devices (e.g., smartphones, tablet computers, etc.) 904b, robots 904c, autonomous vehicles 904d, wearable devices, virtual reality, augmented reality, or mixed reality devices (not shown), or others. Client devices 904 may be configured for sending data to and/or receiving data from the server 902, and may include, but need not include, one or more output devices, such as but not limited to displays, printers, etc. for displaying or printing results of certain methods that are provided for display by the server. Client devices may include combinations of client devices.

In an example training method the server 902 or client devices 904 may receive a dataset from any suitable source, e.g., from memory 910 (as nonlimiting examples, internal storage, an internal database, etc.), from external (e.g., remote) storage 912 connected locally or over the network 906. The example training method can generate a trained model that can be likewise stored in the server (e.g., memory 910), client devices 904, external storage 912, or combination. In some example embodiments provided herein, training and/or inference may be performed offline or online (e.g., at run time), in any combination. Results can be output (e.g., displayed, transmitted, provided for display, printed, etc.) and/or stored for retrieving and providing on request.

In an example document processing method the server 902 or client devices 904 may receive one or more documents from any suitable source, e.g., by local or remote input from a suitable interface, or from another of the server or client devices connected locally or over the network 906. Trained models such as the example neural ranking model can be likewise stored in the server (e.g., memory 910), client devices 904, external storage 912, or combination. In some example embodiments provided herein, training and/or inference may be performed offline or online (e.g., at run time), in any combination. Results can be output (e.g., displayed, transmitted, provided for display, printed, etc.) and/or stored for retrieving and providing on request.

In an example retrieval method the server 902 or client devices 904 may receive a query from any suitable source, e.g., by local or remote input from a suitable interface, or from another of the server or client devices connected locally or over the network 906 and process the query using example neural models (or by a more straightforward tokenization, in some example methods). Trained models such as the example neural can be likewise stored in the server (e.g., memory 910), client devices 904, external storage 912, or combination. Results can be output (e.g., displayed, transmitted, provided for display, printed, etc.) and/or stored for retrieving and providing on request.

Generally, embodiments can be implemented as computer program products with a program code or computer-executable instructions, the program code or computer-executable instructions being operative for performing one of the methods when the computer program product runs on a computer. The program code or the computer-executable instructions may, for example, be stored on a computer-readable storage medium.

In an embodiment, a storage medium (or a data carrier, or a computer-readable medium) comprises, stored thereon, the computer program or the computer-executable instructions for performing one of the methods described herein when it is performed by a processor.

Embodiments described herein may be implemented in hardware or in software. The implementation can be performed using a non-transitory storage medium such as a computer-readable storage medium, for example a floppy disc, a DVD, a Blu-Ray, a CD, a ROM, a PROM, and EPROM, an EEPROM or a FLASH memory. Such computer-readable media can be any available media that can be accessed by a general-purpose or special-purpose computer system.

General

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure. All documents cited herein are hereby incorporated by reference in their entirety, without an admission that any of these documents constitute prior art.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general purpose computer to execute one or more particular functions embodied in computer programs. The functional blocks, flowchart components, and other elements described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

1. A method implemented by a computer having a processor and memory for providing a representation of an input sequence over a vocabulary in a ranker of a neural information retrieval model, the method comprising:
embedding each token of a tokenized input sequence based at least on the vocabulary to provide an embedded input sequence, the tokenized input sequence being tokenized using the vocabulary;
determining a prediction of an importance of each token over the vocabulary with respect to each token of the embedded input sequence;
obtaining a predicted term importance of the input sequence as a representation of the input sequence over the vocabulary by performing an activation over the embedded input sequence; and
outputting the predicted term importance of the input sequence as the representation of the input sequence over the vocabulary in the ranker of the neural information retrieval model;
wherein said embedding and said determining a prediction are performed by a pretrained language model.

2. The method of claim 1, wherein the activation comprises a concave activation function.

3. The method of claim 2, wherein the concave activation function comprises a logarithmic activation function or a radical function.

4. The method of claim 2, wherein the concave activation function comprises a logarithmic activation function, wherein said logarithmic activation comprises:
for each token in the vocabulary, determining a maximum of a log-saturation of the determined importance of the token in the vocabulary over the embedded input sequence, wherein the log-saturation prevents some terms in the vocabulary from dominating and ensures sparsity in the representation.

5. The method of claim 1, wherein the concave activation function comprises a logarithmic activation function, wherein said logarithmic activation comprises:
for each token in the vocabulary, combining a log-saturation of the determined importance of the token in the vocabulary over the embedded input sequence, wherein the log-saturation prevents some terms in the vocabulary from dominating and ensures sparsity in the representation.

6. The method of claim 1, further comprising:
tokenizing a received query using the vocabulary;
determining a ranking score for each of a plurality of candidate sequences, the candidate sequences being respectively associated with candidate documents, wherein said determining a ranking score comprises:
determining the output predicted term importance for the candidate sequence for each vocabulary token in the tokenized query; and
combining the determined output predicted term importances;
ranking the plurality of candidate sequences based on said determined ranking score; and
retrieving a subset of the candidate documents having a highest ranking.

7. The method of claim 1, wherein the ranker is in a first stage of the information retrieval model, the information retrieval model further including a second stage that is a re-ranker stage.

8. The method of claim 1, further comprising:
comparing the output predicted term importance for the input sequence to a previously determined predicted term importance for each of a plurality of candidate sequences, the candidate sequences being respectively associated with candidate documents;
ranking the plurality of candidate sequences based on said comparing;
retrieving a subset of the candidate documents having a highest ranking.

9. The method of claim 8, wherein said comparing comprises calculating a dot product between the output predicted term importance of the input sequence and the predicted term importance for each of the plurality of candidate sequences.

10. The method of claim 1, wherein said embedding each token of the tokenized input sequence is based at least on the vocabulary and the token's position within the input sequence to provide context embedded tokens.

11. The method of claim 10, wherein said determining a prediction comprises:
transforming the context embedded tokens using at least one log it function to predict an importance of each token in the vocabulary with respect to each token of the embedded input sequence.

12. The method of claim 11, wherein the at least one log it function is provided by one or more linear layers, each including an activation and a normalization layer;
the one or more linear layers combining the transformation with the respective vocabulary token of the embedded input sequence and a token-level bias.

13. The method of claim 1, wherein the pretrained language model comprises a transformer architecture.

14. The method of claim 13, wherein the language model is pretrained using a masked language modeling method.

15. The method of claim 1, wherein said performing a concave activation function comprises, for each token in the embedded input sequence, applying an activation function to the determined importance of the token in the vocabulary over the embedded input sequence to ensure the positivity of the determined term weights, and performing a concave function on the result of the activation function.

16. A neural model implemented by a computer having a processor and memory for providing a representation of an input sequence over a vocabulary in a ranker of a neural information retrieval model, the model comprising:
a pretrained language model layer configured to embed each token in a tokenized input sequence with contextual features within the embedded input sequence to provide context embedded tokens and to predict an importance with respect to each token of the embedded input sequence over the vocabulary by transforming the context embedded tokens using one or more linear layers, wherein the tokenized input sequence is tokenized using the vocabulary; and
a representation layer configured to receive the predicted importance with respect to each token over the vocabulary and obtain a predicted term importance of the input sequence over the vocabulary, said representation layer comprising a concave activation layer configured to perform a concave activation of the predicted importance over the embedded input sequence;
wherein the representation layer outputs the predicted term importance of the input sequence as the representation of the input sequence over the vocabulary in the ranker of the neural information retrieval model.

17. The neural model of claim 16,
wherein the predicted term importance of the input sequence can be used to retrieve a document; and
wherein the pretrained language model layer is further configured to embed each token of the tokenized input sequence based at least in part on the token's position within the input sequence.

18. The neural model of claim 16, wherein the pretrained language model layer is pretrained using a masked language model (MLM) training method.

19. The neural model of claim 16, wherein the pretrained language model layer comprises a bidirectional encoder representations from transformers (BERT) model.

20. The neural model of claim 16, wherein each of the one or more linear layers comprises a log it function comprising activation and a normalization layer, the linear layers combining the transformation with the respective vocabulary token of the embedded input sequence and a token-level bias.

21. The neural model of claim 16, wherein said concave activation layer is configured to, for each token in the vocabulary, combine or maximize a log-saturation of the determined importance of the token over the vocabulary and over the embedded input sequence, wherein the log-saturation prevents terms in the vocabulary from dominating and provides sparsity in the representation.

22. The neural model of claim 16, wherein said concave activation layer is configured to apply an activation function to the determined importance of the token in the vocabulary over the embedded input sequence to ensure positivity of the determined importance, and applying a concave function on the result of the activation function.

23. The neural model of claim 16, wherein the neural model is incorporated in a first-stage ranker;
wherein the first-stage ranker is further configured to:
compare the predicted term importance for the input sequence to predicted term importance for each of a plurality of candidate sequences generated by the neural model, the candidate sequences being respectively associated with candidate documents;
rank the plurality of candidate sequences based on said comparing; and
retrieve a subset of the documents having a highest ranking.

24. The neural model of claim 23, wherein said comparing comprises calculating a dot product between the output predicted term importance and the predicted term importance for each of the plurality of candidate sequences.

25. The neural model of claim 16, wherein the neural model is incorporated in the first-stage ranker;
wherein the first-stage ranker is further configured to:
determine a ranking score for each of a plurality of candidate documents using the neural model; and
rank the plurality of candidate documents based on the determined ranking score;
wherein said determining a ranking score comprises:
determine the representation for each candidate document over the vocabulary; and
compare the determined representation to a representation of a received input sequence to determine the ranking score;
the first-stage ranker being further configured to retrieve a subset of the documents having a highest ranking.

26. The neural model of claim 25, wherein the representation of the new input sequence is determined using the neural model.

27. The neural model of claim 25, wherein the representation of the new input sequence is determined at least by tokenizing the new input sequence over the vocabulary.

28. The neural model of claim 25, wherein said determining the representation for each candidate document of the vocabulary is performed offline.

29. A computer implemented method for training of a neural model for providing a representation of an input sequence over a vocabulary in a ranker of an information retriever, the method comprising:
providing the neural model with: (i) a tokenizer layer configured to tokenize the input sequence using the vocabulary; (ii) an input embedding layer configured to embed each token of the tokenized input sequence based at least on the vocabulary; (iii) a predictor layer configured to predict an importance for each token of the input sequence over the vocabulary, and (iv) a representation layer configured to receive the predicted importance with respect to each token over the vocabulary and obtain a predicted term importance of the input sequence over the vocabulary, said representation layer comprising a concave activation layer configured to perform a concave activation of the predicted importance over the input sequence,
initializing parameters of the neural model; and
training the neural model using a dataset comprising a plurality of documents;
wherein said training the neural model jointly optimizes a loss comprising a ranking loss and at least one sparse regularization loss; and
wherein the ranking loss and/or the at least one sparse regularization loss is weighted by a weighting parameter.

30. The method of claim 29, wherein the dataset comprises a plurality of documents.

31. The method of claim 29, wherein the dataset comprises a plurality of queries and, for each of the queries, at least one positive document associated with the query and at least one negative document not associated with the query.

32. The method of claim 31,
wherein said training uses a plurality of batches;
wherein each batch includes a plurality of queries, and, for each of the queries, each of: a positive document associated with the query, at least one negative document that is a positive document associated with other queries, and at least one hard negative document not associated with any of the queries in the batch, the at least one hard negative document being generated by sampling a model.

33. The method of claim 32, wherein the at least one negative document not associated with the query is generated by a ranking model.

34. The method of claim 29,
wherein the sparse regularization loss is calculated for each of queries and documents, each being weighted by a weight parameter.

35. The method of claim 29,
wherein the sparse regularization loss comprises one or more of:
an [symbol] ₁ regularization loss for minimizing the [symbol] ₁ norm of the sparse representations generated by the neural model; or
a FLOPS regularization loss for smooth relaxation of an average number of floating-point operations for computing a score of documents.

36. The method of claim 29, further comprising:
distillation training the first-stage ranker and a re-ranker using generated training triplets, each triplet comprising a query, a relevant passage, and a non-relevant passage;
using the trained first-stage ranker to generate new training triplets, the generated triplets comprising harder negatives;
using the trained re-ranker to generate desired scores from the generated new training triplets; and
second training the first-stage ranker using said generated new training triplets and desired scores.

37. The method of claim 36, wherein said second training is from scratch.

38. The method of claim 36, wherein the training is performed offline.

39. A non-transitory computer-readable medium having executable instructions stored thereon for causing a processor and a memory to implement a method for providing a representation of an input sequence over a vocabulary in a first-stage ranker of a neural information retrieval model, the method comprising:
embedding each token of a tokenized input sequence based at least on the vocabulary to provide an embedded input sequence of tokens, the tokenized input sequence being tokenized using the vocabulary;
determining a prediction of an importance of each token over the vocabulary with respect to each token of the embedded input sequence; and
obtaining a predicted term importance of the input sequence as a representation of the input sequence over the vocabulary by performing an activation using a concave activation function over the embedded input sequence; and
outputting the predicted term importance;
wherein said embedding and said determining a prediction are performed by a pretrained language model.

40. A computed implemented method for processing an input sequence, the method comprising:
embedding each token of a tokenized input sequence based at least on a predetermined vocabulary to provide an embedded input sequence of tokens;
predicting term importance of the embedded input sequence of tokens over the predetermined vocabulary; and
outputting the predicted term importance of the input sequence of tokens;
wherein the predicted term importance of the input sequence of tokens provides a representation of the input sequence over a predetermined vocabulary in a first-stage ranker of a neural information retrieval model.

41. The method of claim 40, wherein said embedding and said predicting use a pretrained language model.

42. The method of claim 40, wherein said predicting obtains the predicted term importance of the input sequence as a representation of the input sequence over the vocabulary by an importance of each token over the vocabulary.

43. The method of claim 42, wherein the input sequence is one of a query and a document sequence.
